(19) United States
(12) Patent Application Publication
(10) Pub. No.: US 2026/0252311 A1
(43) Pub. Date: Aug. 27, 2026

(54) PROCESSOR

(71) Applicant: Arm Limited, Cambridge (GB)

(72) Inventors: John Wakefield BROTHERS, III, Calistoga, CA (US); Fredrik Peter STOLT, Lund (SE)

(21) Appl. No.: 19/065,377

(22) Filed: Feb. 27, 2025

(51) Int. Cl. G06F 7/544; G06F 7/556; G06F 9/30

(52) U.S. Cl. CPC G06F 7/5443; G06F 7/556; G06F 9/30014

(57) ABSTRACT

A processor comprises a first processing circuitry configured to process the data in a lower-precision format and a second processing circuitry configured to process data in a higher-precision format. The first processing circuitry is configured to process a data element value using less power than the second processing circuitry processing the same data element value. The method comprises determining whether a data element value will be subject to a transpose operation. In a case that the data element value will be subject to a transpose operation, the processor converts the data element value to the higher precision format and processes the data element value using the second processing circuitry. In a case that the data element value in the lower precision format will not be subject to a transpose operation, the processor processes the data element value in the lower precision format using the first processing circuitry.

### TECHNICAL FIELD

The present invention relates to a processor and a method performed by a processor.

### BACKGROUND

Machine learning models are finding an increasing number of different applications. A neural network is a type of machine learning model that has a plurality of interconnected nodes or neurons in layers. Data is processed by nodes at each layer, typically by multiplying data values with predetermined weight values associated with the neural network. The outputs of each node are passed to one or more nodes in a succeeding layer. In some cases, neural networks may include a large number of nodes causing the number of weights to become large.

Machine learning models may use floating point or other formats of different levels of precision to represent weight and other values. Using lower precision data formats may reduce the size required to store a neural network. This may come at the cost of a loss of accuracy, which may or may not be acceptable depending upon the application.

Neural networks may be processed using a processor. However, it is expensive for a processor to include dedicated hardware to efficiently process weight values and/or input values in many different data formats that may need to be processed for different machine learning models.

Accordingly, there is a desire for a processor that includes processing circuitry that can efficiently handle processing operations for different data formats.

### SUMMARY

According to a first aspect there is provided a method performed by a processor to process data in a lower precision format that uses a per-block scaling factor for a block of a plurality of data element values, wherein the processor comprises a first processing circuitry configured to process the data in the lower precision format and a second processing circuitry configured to process data in a higher precision format, wherein the data in the lower precision format has a lower or equal precision to the data in the higher precision format and the first processing circuitry is configured to process one or more data element value in the lower precision format with an improved performance characteristic compared to the second processing circuitry processing the same one or more data element value in the higher precision format, the method comprising: receiving data that uses a per-block scaling factor to be processed; determining whether a data element value of the data will be subject to a transpose operation; and in a case that it is determined that the data element value will be subject to a transpose operation: converting the data element value to the higher precision format, and processing the data element value in the higher precision format using the second processing circuitry; and in a case that it is determined the data element value will not be subject to a transpose operation: processing the data element value using the first processing circuitry.

According to a second aspect there is provided a processor comprising: a format conversion unit configured to receive data that uses a per-block scaling factor and determine whether the data will be subject to a transpose operation; first processing circuitry configured to process data in a lower precision format wherein the lower precision format uses a per-block scaling factor for a block of a plurality of data element values; and second processing circuitry configured to process data in a higher precision format, wherein the data in the lower precision format has a lower or equal precision to the data in the higher precision format and the first processing circuitry is configured to process one or more data element value in the lower precision format with an improved performance characteristic compared to the second processing circuitry processing the same one or more data element value in the higher precision format; wherein the processor is configured so that: in a case that it is determined by the format conversion unit that a data element value will be subject to a transpose operation, the format conversion unit converts the data element value to the higher precision format, and the data element value in the higher precision format is processed by the second processing circuitry; and in a case that it is determined by the format conversion unit that the data element value will not be subject to a transpose operation, the data element value is processed in the lower precision format using the first processing circuitry.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing processing of a neural network;

FIG. 2 is a schematic diagram showing components within an information processing apparatus;

FIG. 3 shows in more detail processing of data elements between storage in the shared buffer and processing by dot product units;

FIGS. 4a and 4b are a schematic illustration of processing of the bytes by a higher-power processing circuitry;

FIGS. 5a and 5b are a schematic illustration of processing of the bytes by a lower-power processing circuitry;

FIG. 6 is a flow chart showing logic performed by a format conversion unit;

FIG. 7 is a schematic diagram of an information processing apparatus; and

FIG. 8 is a diagram showing one or more packaged chips.

### DETAILED DESCRIPTION

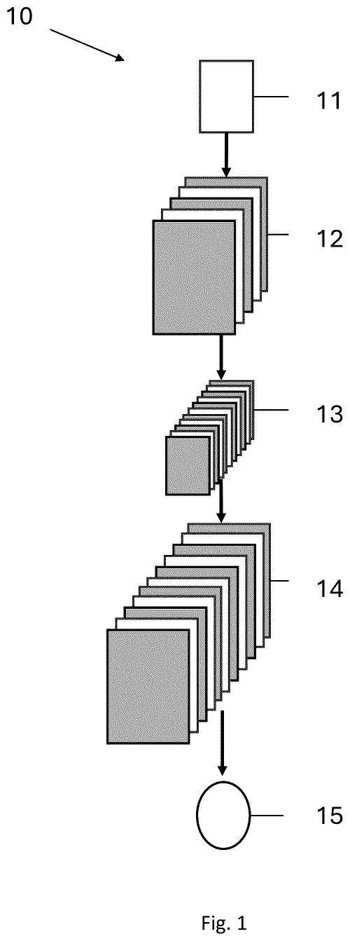

FIG. 1 is a schematic diagram showing stages of processing of a neural network 10. An input tensor is received at input layer 11, and is processed through multiple hidden layers 12, 13 and 14. Each layer is made up of a given number of nodes-this number of nodes is referred to as the size of the layer in question. At each layer, filters are applied to values in the preceding layer to generate, for convolution layers, one or more feature maps. These filters may consist of a variety of operations, including but not limited to convolutional operations and pooling operation. Depending on the filter applied, each layer will have different processing requirements. Once all the layers 12, 13 and 14 have been passed through, an output 15 is generated. The neural network 10 is shown with three layers, but in general a neural network may have any number of layers.

In the first layer 11, a first set of filters are applied to the input tensor to generate one or more output feature maps. At each subsequent layer 12, 13 and 14, the filters of that layer act on the feature maps generated from the previous layer. These filter maps are comprised of data, the amount of which may exceed a local memory capacity of a processor processing the neural network, meaning that at each layer 12, 13 and 14 the data that makes up the feature map from the previous layer may need to be read from an external memory, such as an L2 or higher-level cache. For some smaller layers it may be possible to process the layer using local memory of the processor without making use of the external memory, however filters (weight values, biases etc.) for the layer will likely need to be fetched from external memory. Once the filters of the current layer have been applied, the data making up the feature map generated by that layer is then written to the external memory in turn, if the layer is too large to be stored using local memory. Depending on the size of the feature map generated, the read and write operations associated with each layer will take a certain amount of time. Typically, for large layers, data will be streamed—that is, the data will be fetched, processed, and potentially written out, continuously.

Depending on the type of neural network and the way that the processor processes the neural network, neural network may have convolutional neural network layers, fully connected layers, recurrent neural network layers, fused layers etc. Similarly, kernel size and depth, stride, and activation function will affect the amount of processing required. Furthermore, the processor may support various optimizations, for example sparsity optimization, that may impact the amount of processing performed by the NPU.

The filters of convolution layers may be formed from the sum of the products between weight values for the node with corresponding input data values from a preceding layer. The sum may be adjusted by a bias term. The resulting value, sometimes referred to as an activation, is then input to an activation function, such as Relu, to generate an output for the node.

During training of a neural network, backpropagation may be used to find gradients to adjust weights of the neural network to fit training data. With this information, there are many methods for training neural networks, such as stochastic gradient descent, Adam, etc.

During forward propagation in a feed-forward neural network, input data or activation data from a preceding layer may be multiplied by weight values of a layer of the neural network. During backpropagation, the chain rule may be used to derive gradients. The transpose of the weight tensor of a current layer may be multiplied by an error from a subsequent layer to determine an error from the current layer. Further, the transpose of the activations input to a layer may be multiplied by an error from the subsequent layer in order to determine how a cost function varies with weight values. Accordingly, during training of a neural network, multiplying matrices of data both with and without transposing the data are common operations.

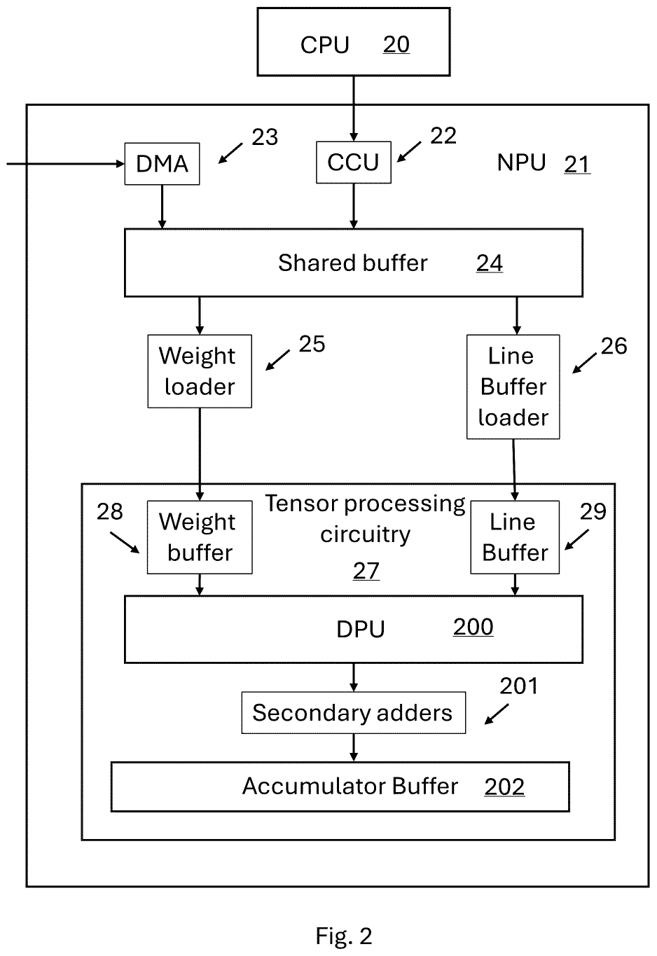

FIG. 2 shows components within an information processing apparatus. A central processing unit, CPU, 20 is connected to a neural processing unit, NPU, 21. Commands may be sent from the CPU 20 and received at a central control unit, CCU, 22 of the NPU 21.

A direct memory access unit, DMA, 23 is configured to operate under control of the CCU 22. The DMA 23 may read data from an external memory into a shared buffer 24 within the NPU 21. In some instances, the data may include weight values and data elements from a tensor comprising feature map data of a machine learning model. In other instances, the data may include data elements from two tensors, wherein the data elements in the two tensors are to be multiplied together.

A weight loader 25 and line buffer loader 26 of the NPU 21 are configured to transfer data from the shared buffer 24 to tensor processing circuitry 27. More particularly, the weight loader 25 is configured to transfer weight values from the shared buffer 24 to a storage in the form of a weight buffer 28. The line buffer loader 26 is configured to transfer data elements from the shared buffer 24 to a storage in the form of a line buffer 29. As will be explained in more detail below, the paths to the line buffer 29 and weight buffer 28 each include a format conversion unit. In other implementations, the line buffer 29 and weight buffer 28 may be connected to a common format conversion unit.

The tensor processing circuitry 27 is configured so that weight values and/or data elements from a tensor are respectively loaded from the weight buffer 28 and line buffer 29 and are input to a set of dot product units, DPU, 200. It is noted that, in the case of matrix multiplication, the weight buffer 28 may contain values other than weight values. A cycle of the tensor processing circuitry 27 (and other components in the NPU 21) is determined by a clock signal from a clock generator (not shown).

Values that have been multiplied and accumulated by the dot product units 200 may be further accumulated in a set of secondary adders 201. Finally, the accumulated data may be stored in an accumulator buffer 202. Data stored in the accumulator buffer 202 may be subject to further processing, such as processing by a vector processing unit. For example, the vector processing unit may optionally perform one of: add a bias, scale, apply an activation function, and format-convert to various different supported output formats. After processing by the tensor processing circuitry and/or vector processing unit, the processed data elements may be written back to the shared buffer 24. Details of any further processing are not relevant to the present disclosure and are not set out in detail.

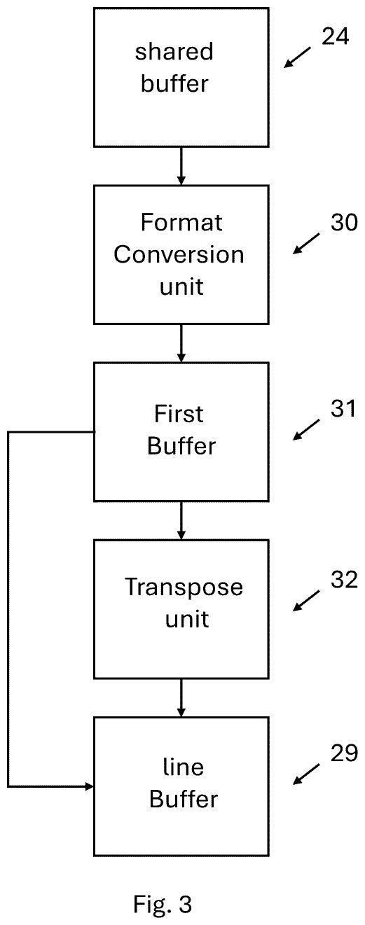

FIG. 3 is a schematic diagram showing in more detail processing of data elements between storage in the shared buffer 24 and processing by the dot product units 200. Similar processing may be performed regardless of whether data elements are eventually stored in the line buffer 29 or the weight buffer 28. Accordingly, the same description applies to processing both between the shared buffer 24 and the line buffer 29 and between the shared buffer 24 and the weight buffer 28 and is not repeated. At the start of the processing, data elements are stored in the shared buffer 24 as described above. The data elements may be read from the shared buffer 24 and processed by the format conversion unit 30. The format conversion unit 30 may either allow the data elements to pass through in their current format, such as an microscaling (MXFP) format, without conversion (or with conversion to a common format that uses a scaling factor as described further below) or convert the data values to a higher-precision regularized format. After conversion or passthrough by the format conversion unit 30, the data elements are stored in a storage in the form of first buffer 31. A transpose unit 32 is provided to transpose the data elements. After transpose processing by the transpose unit 32, the transposed data elements may be stored in the line buffer 29. If the data elements are not processed by the transpose unit 32, they may bypass the transpose unit 32 as illustrated.

In FIG. 3 the transpose unit 32 is shown located between a first buffer 31 and a line buffer 29. In other implementations, the transpose unit 32 may be directly connected to either the format conversion unit 30 or the dot product units 200 and the first buffer 31 may be omitted.

The format conversion unit 30 is configured to receive data elements, each data element being in one of a plurality of different data formats. As noted above, the format conversion unit 30 may be configured to receive data in a format that uses a scale factor, such as MXFP.

MXFP data formats are compressed data formats defined by the Open Compute Project under the OCP Microscaling Formats (MX) Specification. MX format data includes a shared scale for a group of data elements, which group of elements is referred to as a block. Each data element is represented in floating point format with a mantissa, an exponent, and a sign bit. Examples of MXFP formats are MXFP8 (where each data element in a block has an FP8 value), MXFP 6 (where each data element in a block has an FP6 value) and MXFP 4 (where each data element in a block has an FP4 value). Each floating-point value contains a sign, an exponent and a mantissa. FP8 comes in two variations—a first with a four-bit exponent and a 3-bit mantissa and a second with a 5-bit exponent and a two-bit mantissa.

The format conversion unit 30 is configured to convert from a plurality of supported formats and to a single higher-precision format (which is an example of a higher precision data format), which will be referred to as the regularized format. In the present example, the regularized format is a modified floating-point format with a sign, an 8-bit exponent, and an 8-bit mantissa. In this example, the implicit bit to the left of the binary point in the mantissa is also stored as part of the regularized format. Accordingly, the regularized format for each byte may comprise the sign bit, an 8-bit exponent and 8-bits of the mantissa.

The dot product units 200 comprise circuitry for performing multiply-accumulate operations. The dot product units 200 may comprise higher-power processing circuitry and lower-power processing circuitry.

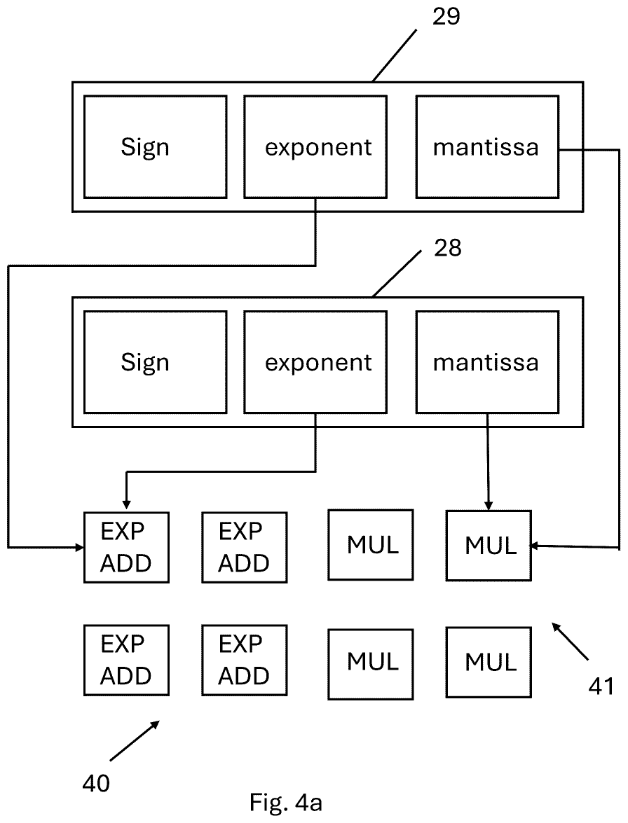

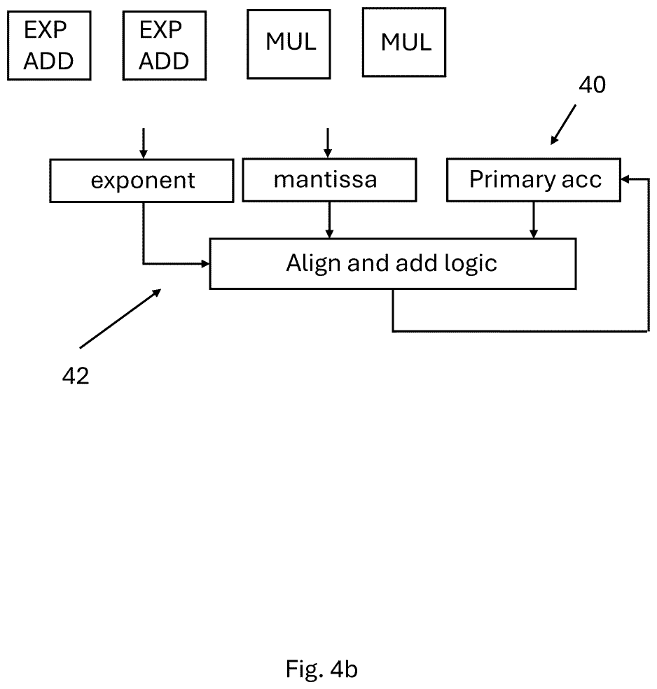

FIGS. 4a and 4b are a schematic illustration of processing of the bytes by higher-power processing circuitry in the dot product units 200. The line buffer 29 stores regularized bytes with a sign, exponent (8-bits) and mantissa of 8-bits per data element.

Similarly, the weight buffer 28 includes regularized bytes with a sign, exponent (8-bits) and mantissa of 8-bits per data element.

The regularized data elements from the line buffer 29 and weight buffer 28 are fed into an array of dot product units 200 that are shown partially in FIG. 4a and partially in FIG. 4b. The dot product units are shown represented by adders 40 and multipliers 41. Multiplication of the input data elements proceeds in two parts. In a first part, the exponents of the two data elements input to the dot product units 200 are added together. In a second part, the mantissa strings of the two data elements are multiplied together in the multipliers. As illustrated in FIG. 4b, the resulting exponent and mantissa are then aligned with the value in a primary accumulator by an align and add logic section 42 and then the values are accumulated (added together) in a primary accumulator 40 of the dot product unit 200.

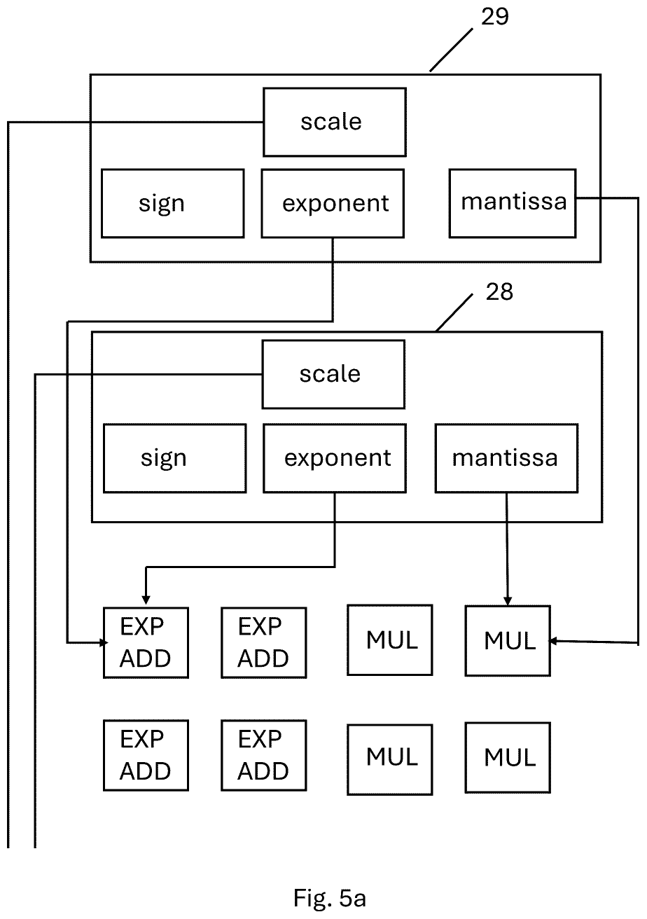

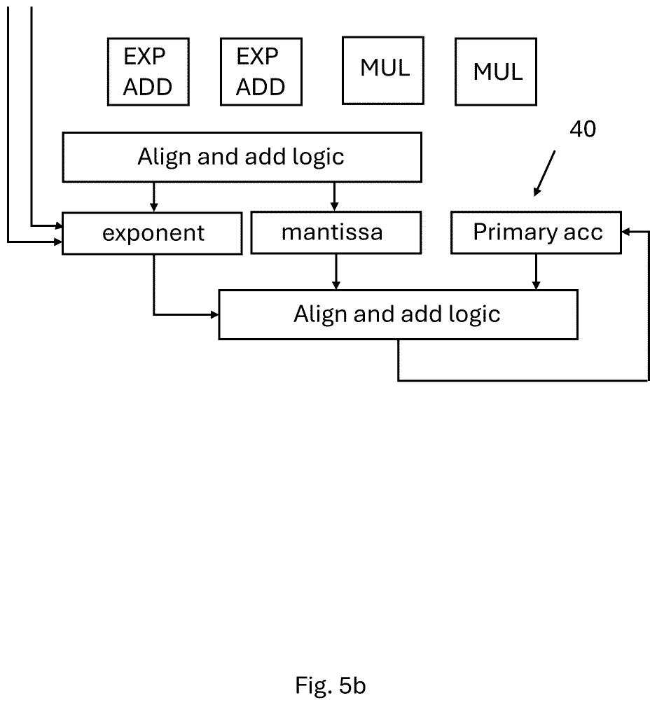

FIGS. 5a and 5b are a schematic illustration of processing of the bytes by a lower-power processing circuitry configured to process data in the lower precision format, such as MXFP8. As noted above, the line buffer 29 stores lower-precision bytes, with a scale, associated with the block of data elements and sign, exponent and mantissa of a data element. In some implementations, the lower-power processing circuitry may support formats up-to MXFP 8 precision. In some implementations, the lower-power processing circuitry may support a predefined lower-precision format as explained further below. In MXFP8, the data element may be in one of two formats: a first with a four-bit exponent and a 3-bit mantissa and a second with a 5-bit exponent and a two-bit mantissa. Accordingly, the lower-power processing circuitry has adders that can handle addition of up to two 5-bit exponents and multiplication of up to two 3-bit mantissas.

Similarly, the weight buffer 28 includes data in the lower precision format with a scale, sign, exponent and mantissa.

The data elements from the line buffer 29 and weight buffer 28 are fed into an array of dot product units 200 that are shown partially in FIG. 5a and partially in FIG. 5b. The dot product units are shown represented by adders and multipliers. Multiplication of the input data elements proceeds in two parts. In a first part, the exponents of the two data elements input to the dot product units 200 are added together. In a second part, the mantissa strings of the two data elements are multiplied together in the multipliers.

As illustrated in FIG. 5b, the exponent of the sum of the data elements is then adjusted based on the two scale factors, which bypassed the adders and multipliers. As the scale factors represent a power of two, the two scale factors are added to the exponent of the sum of the two data elements. In some implementations a check for overflow of the exponent may be performed. In other implementations, the bit width of the align and add logic is large enough to avoid overflow of the exponent. In either case, if an overflow is detected or the final sum into the primary accumulator 40 overflows, the value may be clamped or converted to infinity.

In general multiple pairs of data elements may be processed in parallel through either the lower-power processing circuitry or higher-power processing circuitry. In such implementations, the exponents may be added together for each pair of multiplier inputs, because and then an alignment step may be performed to align the mantissas of the multiplier outputs before performing a floating point add to any existing total in the primary accumulator 40. The result is a single exponent and mantissa for the sum which is stored in the primary accumulator 40.

The lower-power processing circuitry is lower-power than the higher-power processing circuitry shown in FIGS. 4a and 4b because the size of each the components is smaller. For example, a smaller bit-width adder tree may be used to add the exponents and a smaller bit-width multiplier may be used to multiply the mantissas in the lower-power processing circuitry.

The primary accumulator 40 may be common between the higher-power processing circuitry and the lower-power processing circuitry to allow values to be accumulated regardless of how they are processed. For example, as will be explained in more detail below, some values from a section of data may be processed by the higher-power processing circuitry and some values from the section of data may be processed by the lower-power processing circuitry and it may be desired to accumulate these values.

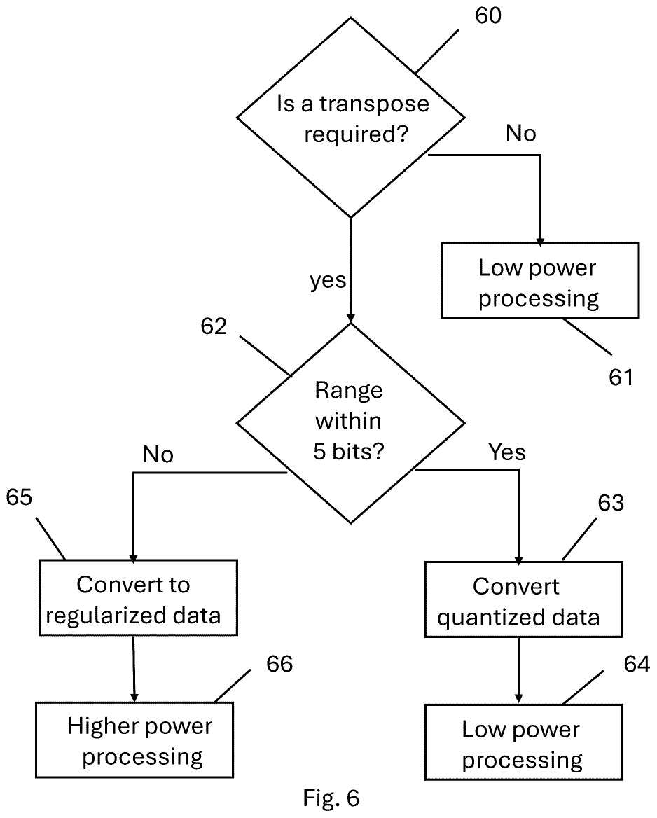

FIG. 6 is a flow chart depicting logic performed by each format conversion unit 30. Data is received by each format conversion unit 30 between the shared buffer 24 and the weight buffer 28 and between the shared buffer 24 and the line buffer 29 (or common format conversion unit if a single format conversion unit is provided for both paths from the weight loader 25 and the path from the line buffer loader 26). The data received at the format conversion unit 30 is read from the shared buffer 24 and may be ordered in row major order across a section of data to be processed. In an illustrative example, the data is received in a lower precision format that uses a per-block scaling factor, such as MXFP8. The blocks of data element values which have a common scaling factor correspond to rows of the section of data.

At step 60, the format conversion unit 32 makes a decision whether a data element being received is to be subject to a transpose operation. The determination at step 60 as to whether the data will be subject to a transpose operation may be based on instructions received from the CPU 20 or CCU 22 that controls operations to be performed on the data elements.

In some implementations, if received data elements are not to be subjected to a transpose operation (step 60, No), the data elements are not converted by the format conversion unit 30 and bypass the transpose unit 32. In other implementations, if received data elements are not to be subjected to a transpose operation (step 60, No), they may be converted by the format conversion unit 30 to a predefined lower-precision format. The predefined low-precision format may be used in cases where the received data elements, which as described above may be a portion of data in an MXFP format, are in lower-precision formats, such as fp4, fp6, and fp8. The predefined lower-precision format may have a sign bit, a five-bit exponent, and a four-bit mantissa. Conversion logic in the format conversion unit 30 may detect denormal values and set the most significant mantissa bit to 0 or 1 accordingly. The conversion logic may also handle incoming values that are infinity and NaN (not a number) which may exist in received low precision formats. In response to detection of these special numbers, the format conversion unit 30 may add two extra bits to indicate NaN, infinity, or not special. When performing format conversion in the weight path, the mantissa and/or exponent may be adjusted in the place of the two extra bits to allow detection of NaN and infinity by the dot product unit 200.

The data elements for which a transpose is not required are processed by the dot product unit 200 to multiply and accumulate the data elements using the lower-power processing circuitry in step 61. As explained in more detail below, the format conversion unit 30 may add a flag to the data elements, or to groups of data elements, that are not to be subject to a transpose operation to allow the dot product units 200 to identify that the data elements are to be processed using the lower-power processing circuitry.

If received data elements are to be subject to a transpose operation by the transpose unit 32 (step 60, yes) then the data elements in the section of data will be transposed by the transpose unit 32. This creates the following difficulty. Following transpose, the data elements would have a scale factor relating to blocks of data elements in columns of the section of data. However, the transposed section of data will be processed row-by-row. In other words, if lower precision data has scale factors associated with blocks of data elements row-wise, following transpose, the data elements will be rearranged and the blocks associated with scale factors in the transposed data will correspond to columns of data elements in the transposed section of data elements. Accordingly, each data element to be processed (in the row of transposed data elements/column of original data elements) will correspond to a different block of MXFP data (or MXFP-like data where the data element has been converted to the predefined lower-precision format) and have a different scaling factor.

A determination is made by the format conversion unit 30 at step 62 whether values in a column of the section of original data have a range of values that can be expressed within a predetermined exponent size. The range can be determined by adding the scale to the exponent value for each data element in the column and looking at the difference between the maximum exponent and the minimum exponent to see if it is less than the predetermined exponent size. The predetermined exponent size may correspond to an exponent bit-width of the lower-power processing circuitry. In this example, the predetermined exponent size is a 5-bit exponent to correspond to formats of MXFP8. If the range of values can be expressed within the predetermined exponent size, then it is possible to convert the data elements in the column so that the data elements can still be processed using the lower-power processing circuitry.

In step 62, the scaling factor for each data element is added to the exponent of the data element in a column of data elements and it is determined whether the range of exponent values within the column can be represented using a 5-bit exponent. If the range of values in a column of the original data (row of the transposed data) can be represented by a 5-bit exponent (step 62, yes), then in step 63 the column of data elements is converted into a lower precision data with a scaling factor for the column. In other words, the data is converted from MXFP (lower precision with a scaling factor) data with data elements in blocks that form rows of the section of data to MXFP (lower precision with a scaling factor) data with data elements in blocks that form columns of the section of data. In more detail, a minimum exponent that is the lowest exponent value of the data elements in the column of the section of data is identified by the format conversion unit 30. The minimum exponent is used as the scaling factor for the column and the data element values for the column of data with the new scaling factor are determined. The resulting column of data elements (row of data elements in the transposed section of data) have a minimum exponent value of zero and a maximum that is something less than the maximum representable exponent, in this example 31. The process effectively converts MXFP (lower precision with a scaling factor) data with blocks running in rows across the original section of data elements to MXFP (lower precision with a scaling factor) data with blocks running across columns of the section of data (which corresponds to rows in the transposed section of data elements). The MXFP (lower precision with a scaling factor) data that has been converted by the format conversion unit 30 is passed to the transpose unit 32 as described above and is processed using the lower-power processing circuitry in step 64. The data elements or groups of the data elements may be flagged by the format conversion unit 30 for processing by the lower-power processing circuitry within the dot product units 200.

If the range of values in a column of data across the section of data cannot be represented by the predetermined exponent size, in this example 5-bits, (step 62, no), then the data values in the column of the original section of data are converted into the regularized data format (sign+8-bit exponent+8-bit mantissa) in step 65. The regularized format has a high enough precision to be able to express all values of the MXFP8 data and so no loss of precision occurs when the transpose if performed by the transpose unit 32. In step 66, the regularized data is passed to the transpose unit 32 as described above and is processed using the higher-power processing circuitry within the dot product units 200. The data elements or groups of data elements may be flagged by the format conversion unit 30 for processing by the higher-power processing circuitry within the dot product units 200.

As noted above, once the format conversion unit 30 has made the determinations in steps 60 and 62, the format conversion unit 30 may add a flag in the form of a precision bit. The precision bit may be added to each data element or to groups of data elements. In one implementation, all data elements processed in a cycle by the dot product units 200 will have the same precision. The precision bit may therefore be associated with a group of data elements for a cycle. The precision bit may be read at the dot-product units 200 to determine whether to process the data element using the lower-power processing circuitry or the higher-power processing circuitry.

By using the logic described in connection with FIG. 6, a greater proportion of data values may be processed using the lower power-circuitry. As the lower-power circuitry operates with a lower power and/or higher throughput a more efficient processing of data element values may be obtained.

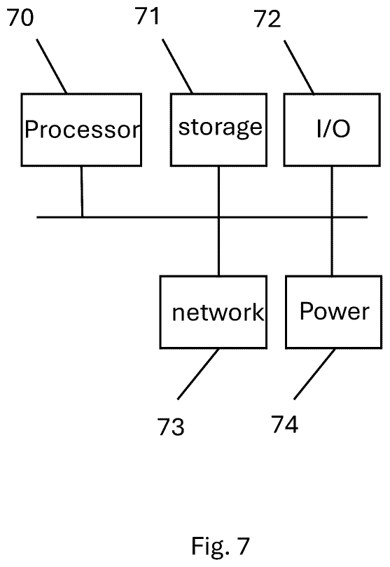

FIG. 7 is a schematic diagram showing hardware of an information processing apparatus. The information processing unit may comprise one or more processor 70, a storage 71, an I/O unit 72, a network unit 73, and a power unit 74. Other components may be present but not shown as is well known in the art.

The one or more processor 70 may include the combination of the CPU 10 and NPU 11 described above. The one or more processors 70 may be configured to perform computations. The processor 70 may consist of one or more a central processing unit (CPU), a graphics processing unit (GPU) and a neural processing unit (NPU). The storage unit 71 may include both volatile (RAM) and non-volatile (ROM, SSD, HDD) memory components. The storage unit 71 may store both the instructions to be executed by the processor and the data on which these instructions operate. The Input/Output Interfaces unit 72 allows the apparatus to communicate with external devices. Input interfaces may include components like a keyboard, mouse, or touchscreen for user interaction, while output interfaces may include a display, printer, or speakers. The network unit 73 may enable the apparatus to connect to networks (e.g., LAN, WAN, Wi-Fi, Bluetooth, etc.) for data exchange. The network unit 73 may include wired or wireless communication modules. The power unit 74 may provide the necessary power for all components of the apparatus. The power unit 74 may be connected to an external power source or include an internal battery for portable use.

The term processing element, processor, or processing unit (terms may be used interchangeably) has been used above to describe a hardware component that performs processing on data. The term encompasses, without limitation, central processing units (CPU), graphical processing units (GPU) and Neural Processing units/Tensor Processing units (NPU/TPU). Where the term CPU, GPU, NPU/TPU has been used this term may be generalized to the term processor.

In some implementations, the processor may comprise a chip. The chip (sometimes referred to as system on a chip SoC) may comprise multiple components, such as CPU, GPU, NPU and storage component. In some implementations, the component may include circuits embedded on a single piece of material, such as a semiconductor wafer. As explained below, which circuits form part of each of the CPU, GPU, and NPU may be a matter of definition rather than inherent properties of the circuits.

The storage may be a unified storage that may be accessible by one, more, or all of the circuits on the chip. Allowing each circuit to access the same storage may improve the speed with which data can be processed.

Terms such as CPU, GPU and NPU are referred to in the art, but their meaning may depend on context. The CPU may be a ‘central’ or ‘main’ processing unit. However, in distributed systems or systems where there are multiple processing cores, the concept of a ‘main’ or ‘central’ processing unit may not be relevant. Further, while a GPU may be a hardware accelerator for graphics processing tasks, a GPU may sometimes be used for accelerating processing of neural networks. Further, there may be aspects of a graphics task that involve processing of neural networks. Accordingly, a GPU may be considered to be an NPU and vice versa depending on the context of the processing and/or intended primary purpose of the processor.

A typical feature of NPU and GPU designs is an ability to perform certain operations in parallel resulting in hardware acceleration. Correspondingly, a trend in CPU design has been the inclusion of an increased numbers of cores that increase the ability to process data in parallel. Accordingly, the presence of parallel processing does not reliably allow to distinguish between processor types.

One or more embodiments above may have been described in the context of one or more of a CPU, GPU, or NPU. For the avoidance of doubt, the techniques described herein may be applied more generally to a processor for the reasons given above.

### Other Aspects

At least some aspects of the examples described herein comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

Concepts described herein may be embodied in a system comprising at least one packaged chip. In some cases, the processor described earlier may be implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

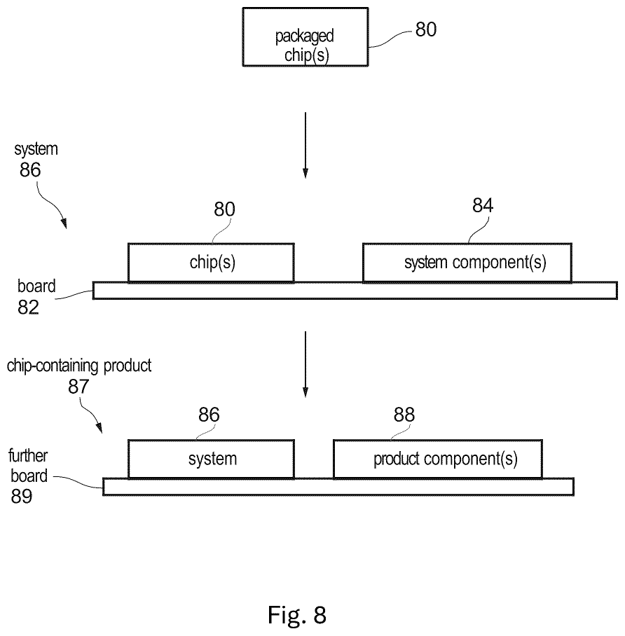

As shown in FIG. 8, one or more packaged chips 80, with the processor described above implemented on one chip or distributed over two or more of the chips, are manufactured by a semiconductor chip manufacturer. In some examples, the chip product 80 made by the semiconductor chip manufacturer may be provided as a semiconductor package which comprises a protective casing (e.g. made of metal, plastic, glass or ceramic) containing the semiconductor devices implementing the processor described above and/or connectors, such as lands, balls or pins, for connecting the semiconductor devices to an external environment. Where more than one chip 80 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 80 are assembled on a board 82 together with at least one system component 84 to provide a system 86. For example, the board may comprise a printed circuit board. The board substrate may be made of any of a variety of materials, e.g. plastic, glass, ceramic, or a flexible substrate material such as paper, plastic or textile material. The at least one system component 84 comprise one or more external components which are not part of the one or more packaged chip(s) 80. For example, the at least one system component 84 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 87 is manufactured comprising the system 86 (including the board 82, the one or more chips 80 and the at least one system component 84) and one or more product components 88. The product components 88 comprise one or more further components which are not part of the system 87. As a non-exhaustive list of examples, the one or more product components 88 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 87 and one or more product components 88 may be assembled on to a further board 89.

The board 82 or the further board 89 may be provided on or within a device housing or other structural support (e.g. a frame or blade) to provide a product which can be handled by a user and/or is intended for operational use by a person or company.

The system 86 or the chip-containing product 87 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

### Further Embodiments

A further embodiment provides a method performed by a processor to process data in a lower precision format that uses a per-block scaling factor for a block of a plurality of data element values. The processor comprises a first processing circuitry configured to process the data in the lower precision format and a second processing circuitry configured to process data in a higher precision format. The data in the lower precision format has a lower or equal precision to the data in the higher precision format and the first processing circuitry is configured to process one or more data element value in the lower precision format with an improved performance characteristic compared to the second processing circuitry processing the same one or more data element value in the higher precision format. The method comprises receiving data that uses a per-block scaling factor to be processed and determining whether a data element value of the data will be subject to a transpose operation. In a case that it is determined that the data element value will be subject to a transpose operation, the processor converts the data element value to the higher precision format and processes the data element value in the higher precision format using the second processing circuitry. In a case that it is determined the data element value will not be subject to a transpose operation, the processor processes the data element value using the first processing circuitry.

In some embodiments the data in the lower precision format has a lower precision to the data in the higher precision format.

The method may further comprise, in a case that the data element value will be subject to a transpose operation, transposing the position of the data element value within received data after conversion to the higher precision format.

The received data may be data in a microscaling format.

In a case that it is determined that the data value will be subject to a transpose operation, the method may comprise: converting the data element value to a floating-point format by applying a respective scale factor to the data element value, identifying a new block comprising a group of data element values that will be processed together in the transposed data, determining a range of values within the new block of transposed data element values, and in a case that the range of values in the new block of data element values is expressible within an exponent bit width of the first processing circuitry, converting the new block of transposed data to the lower precision format using a per-block scaling factor for the new block, and processing the data element values using the first processing circuitry.

Converting each new block of transposed data to the lower precision format may comprise identifying a minimum exponent value of the converted data element values in the new block of data and using the minimum exponent as a scale factor for the new block. The data in a lower-precision format may represent a two-dimensional array of data. The blocks may be rows of the two-dimensional array of data, and the new blocks may be columns of the two-dimensional array of data.

The lower precision format that uses a per-block scaling factor may comprise a plurality of data elements in each block, each data element having an exponent and a mantissa. The first processing circuitry may be configured to perform a multiply accumulate operation using a first data element in a lower precision format and a second data element in a lower precision format by adding the exponent of the first data element, the block scaling factor of the first data element, the exponent of the second data element and the block scaling factor of the second data element and by multiplying the mantissa of the first data element with the mantissa of the second data element.

The data in the higher precision format may be data in a higher-precision floating-point format. The second processing circuitry may be configured to perform a multiply accumulate operation using the a first data element in the higher precision floating point format and a second data element in the higher precision floating point format by adding an exponent of the first data element and an exponent of the second data element and by multiplying the mantissa of the first data element with the mantissa of the second data element.

The first processing circuitry may use a first adder to add exponents of the data in a lower precision format and the second processing circuitry may use a second adder to add exponents of data in the higher precision format. A bit-width of the first adder may be smaller than a bit-width of the second adder.

The first processing circuitry may use a first multiplier to multiply mantissas of the data in a lower precision format and the second processing circuitry may use a second multiplier to multiply mantissas of data in the higher precision format. A bit-width of the first multiplier may be smaller than a bit-width of the second multiplier.

Determining whether the data will be subject to a transpose operation may be performed by a format conversion unit and the format conversion unit may add a flag to one or more data elements to indicate whether the one or more data elements should be processed by the first processing circuitry or the second processing circuitry.

The improved performance characteristic may be at least one of lower power and higher throughput or processed data element values per unit time.

A further embodiment may provide a processor comprising a format conversion unit configured to receive data that uses a per-block scaling factor and determine whether the data will be subject to a transpose operation. The processor comprises first processing circuitry configured to process the data in the lower precision format. The lower precision format uses a per-block scaling factor for a block of a plurality of data element values. The processor comprises second processing circuitry configured to process data in a higher precision format, wherein the data in the lower precision format has a lower or equal precision to the data in the higher precision format. The first processing circuitry is configured to process a data element value in the lower precision format with an improved performance characteristic compared to the second processing circuitry processing the same data element value in the higher precision format. The processor is configured so that: in a case that it is determined by the format conversion unit that a data element value will be subject to a transpose operation, the format conversion unit converts the data element value to the higher precision format, and the data element value in the higher precision format is processed by the second processing circuitry. The processor is also configured so that in a case that it is determined by the format conversion unit that the data element value will not be subject to a transpose operation, the data element value is processed in the lower precision format using the first processing circuitry.

A system may comprise the processor described above, implemented in at least one packaged chip; at least one system component; and a board, wherein the at least one packaged chip and the at least one system component are assembled on the board.

A chip-containing product may be provided comprising the aforementioned system, wherein the system is assembled on a further board with at least one other product component.

A non-transitory computer-readable medium may be provided having stored thereon computer-readable code for fabrication of the above-described processor.

1. A method performed by a processor to process data in a lower precision format that uses a per-block scaling factor for a block of a plurality of data element values, wherein the processor comprises a first processing circuitry configured to process the data in the lower precision format and a second processing circuitry configured to process data in a higher precision format, wherein the data in the lower precision format has a lower or equal precision to the data in the higher precision format and the first processing circuitry is configured to process one or more data element value in the lower precision format with an improved performance characteristic compared to the second processing circuitry processing the same one or more data element value in the higher precision format, the method comprising:
receiving data that uses a per-block scaling factor to be processed;
determining whether a data element value of the data will be subject to a transpose operation; and
in a case that it is determined that the data element value will be subject to a transpose operation:
converting the data element value to the higher precision format, and
processing the data element value in the higher precision format using the second processing circuitry; and
in a case that it is determined the data element value will not be subject to a transpose operation:
processing the data element value using the first processing circuitry.

2. A method according to claim 1, further comprising, in a case that the data element value will be subject to a transpose operation, transposing the position of the data element value within received data after conversion to the higher precision format.

3. A method according to claim 1, wherein the received data is data in a microscaling format.

4. A method according to claim 1, wherein in a case that it is determined that the data value will be subject to a transpose operation, the method comprises:
converting the data element value to a floating-point format by applying a respective scale factor to the data element value,
identifying a new block comprising a group of data element values that will be processed together in the transposed data,
determining a range of values within the new block of transposed data element values, and
in a case that the range of values in the new block of data element values is expressible within an exponent bit width of the first processing circuitry, converting the new block of transposed data to the lower precision format using a per-block scaling factor for the new block, and
processing the data element values using the first processing circuitry.

5. A method according to claim 4, wherein converting each new block of transposed data to the lower precision format comprises identifying a minimum exponent value of the converted data element values in the new block of data and using the minimum exponent as a scale factor for the new block.

6. A method according to claim 4, wherein the data in a lower-precision format represents a two-dimensional array of data, the blocks are rows of the two-dimensional array of data, and the new blocks are columns of the two-dimensional array of data.

7. A method according to claim 1, wherein the lower precision format that uses a per-block scaling factor comprises a plurality of data elements in each block, each data element having an exponent and a mantissa.

8. A method according to claim 7, wherein the first processing circuitry is configured to perform a multiply accumulate operation using a first data element in a lower precision format and a second data element in a lower precision format by adding the exponent of the first data element, the block scaling factor of the first data element, the exponent of the second data element and the block scaling factor of the second data element and by multiplying the mantissa of the first data element with the mantissa of the second data element.

9. A method according to claim 1, wherein the data in the higher precision format is data in a higher-precision floating-point format.

10. A method according to claim 9, wherein the second processing circuitry is configured to perform a multiply accumulate operation using the a first data element in the higher precision floating point format and a second data element in the higher precision floating point format by adding an exponent of the first data element and an exponent of the second data element and by multiplying the mantissa of the first data element with the mantissa of the second data element.

11. A method according to claim 1, wherein the first processing circuitry uses a first adder to add exponents of the data in a lower precision format and the second processing circuitry uses a second adder to add exponents of data in the higher precision format and a bit-width of the first adder is smaller than a bit-width of the second adder.

12. A method according to claim 1, wherein determining whether the data will be subject to a transpose operation is performed by a format conversion unit and the format conversion unit adds a flag to one or more data elements to indicate whether the one or more data elements should be processed by the first processing circuitry or the second processing circuitry.

13. A method according to claim 1, wherein the improved performance characteristic is at least one of lower power and higher throughput of processed data element values per unit time.

14. A processor comprising:
a format conversion unit configured to receive data that uses a per-block scaling factor and determine whether the data will be subject to a transpose operation;
first processing circuitry configured to process data in a lower precision format wherein the lower precision format uses a per-block scaling factor for a block of a plurality of data element values; and
second processing circuitry configured to process data in a higher precision format, wherein the data in the lower precision format has a lower or equal precision to the data in the higher precision format and the first processing circuitry is configured to process one or more data element value in the lower precision format with an improved performance characteristic compared to the second processing circuitry processing the same one or more data element value in the higher precision format;
wherein the processor is configured so that:
in a case that it is determined by the format conversion unit that a data element value will be subject to a transpose operation, the format conversion unit converts the data element value to the higher precision format, and
the data element value in the higher precision format is processed by the second processing circuitry; and
in a case that it is determined by the format conversion unit that the data element value will not be subject to a transpose operation, the data element value is processed in the lower precision format using the first processing circuitry.

15. A system comprising:
the processor of claim 14, implemented in at least one packaged chip;
at least one system component; and
a board,
wherein the at least one packaged chip and the at least one system component are assembled on the board.

16. A chip-containing product comprising the system of claim 15, wherein the system is assembled on a further board with at least one other product component.

17. A non-transitory computer-readable medium having stored thereon computer-readable code for fabrication of the processor of claim 14.
